(19) United States
(12) Patent Application Publication
(10) Pub. No.: US 2025/0038174 A1
(43) Pub. Date: Jan. 30, 2025

(54) NEGATIVE ELECTRODE FOR SOLID ELECTROLYTE BATTERY AND SOLID ELECTROLYTE BATTERY

(71) Applicant: TDK CORPORATION, Tokyo (JP)

(72) Inventors: Hisashi SUZUKI, Tokyo (JP); Akinobu NOJIMA, Tokyo (JP); Masato KURIHARA, Tokyo (JP); Taisuke HORIKAWA, Tokyo (JP)

(73) Assignee: TDK CORPORATION, Tokyo (JP)

(21) Appl. No.: 18/716,716

(22) PCT Filed: Nov. 24, 2022
(86) PCT No.: PCT/JP2022/043340

§ 371 Date: Jun. 5, 2024

(30) Foreign Application Priority Data
Dec. 27, 2021 (JP) 2021-211929

(51) Int. Cl. H01M 4/36; H01M 4/02; H01M 4/587; H01M 4/62; H01M 10/0562

(52) U.S. Cl. CPC H01M 4/364; H01M 4/587; H01M 4/62; H01M 10/0562; H01M 2004/027; H01M 2300/008

(57) ABSTRACT

A negative electrode for a solid electrolyte battery includes a negative electrode active material, a first compound, and a second compound, wherein the first compound is AₐE_{b}G_{c}X_{d} . . . (1), the second compound is different from the first compound, and is at least one of LiX . . . (2) and LiₐE_{b}F_{g}X_{d} . . . (3), in Formulae (1) to (3), A is Li, or Li and Na or Ca, E is at least one element selected from the group consisting of Al, Sc, Y, Zr, Hf, and lanthanoids, G is a predetermined group, X is at least one element selected from the group consisting of F, Cl, Br, and I, and 0.5≤a<6, 0<b<2, 0.1<c≤6, 0<d≤6.1, 0.5≤e<6, 0<f<2, 1.3≤g≤6.1, and 0≤h≤6.1 are satisfied.

### TECHNICAL FIELD

The present invention relates to a negative electrode for a solid electrolyte battery and a solid electrolyte battery. Priority is claimed on Japanese Patent Application No. 2021-211929, filed Dec. 27, 2021, the content of which is incorporated herein by reference.

### BACKGROUND ART

In recent years, the development of electronics technology has remarkably progressed, and portable electronic devices have become smaller, lighter, thinner, and more multifunctional. Accordingly, there is a strong demand for batteries serving as electronic device power sources to be smaller, lighter, thinner, and more reliable and solid electrolyte batteries that use solid electrolytes as electrolytes have been focused on. As solid electrolytes, oxide-based solid electrolytes, sulfide-based solid electrolytes, complex hydride-based solid electrolytes and the like are known.

For example, Patent Document 1 describes a solid electrolyte battery using an oxide-based solid electrolyte. Patent Document 1 states that, when a specific electrode and a solid electrolyte layer both contain a lithium halide, the adhesion between their interfaces is improved. In addition, Patent Document 2 describes an all-solid-state battery using a complex hydride solid electrolyte containing an alkali metal compound. In addition, Patent Document 3 describes an all-solid-state lithium battery using a sulfide-based solid electrolyte containing a lithium halide.

### CITATION LIST

### Patent Document

### [Patent Document 1]

Japanese Unexamined Patent Application, First Publication No. 2019-91583

### [Patent Document 2]

Japanese Unexamined Patent Application, First Publication No. 2016-18679

### [Patent Document 3]

Japanese Unexamined Patent Application, First Publication No. 2017-79126

### SUMMARY OF INVENTION

### Technical Problem

Oxide-based solid electrolytes, sulfide-based solid electrolytes, and complex hydride-based solid electrolytes have different properties because they are composed of different materials. In recent years, halide-based solid electrolytes have been considered as solid electrolytes that may have higher ion conductivity than these solid electrolytes.

Patent Document 1 describes the problem of insufficient physical and electrical connection between electrodes (a positive electrode and/or a negative electrode) and a solid electrolyte layer in the main body of a battery. In order to address this problem, Patent Document 1 states that at least one specific electrode of the positive electrode and the negative electrode contains a lithium halide. Since adhesion between the electrode and the solid electrolyte layer increases according to plastic deformation of the lithium halide, in the battery of Patent Document 1, it is not necessary to separately provide a member for fixing external pressure. As a result, the battery of Patent Document 1 has an improved energy density.

Patent Document 2 states that high ion conductivity can be achieved using a mixture of a complex hydride solid electrolyte and a lithium halide.

Patent Document 3 describes a problem in which, when an all-solid-state lithium battery in a charged state is exposed to a high temperature, the elemental oxygen (O) contained in the positive electrode active material and the elemental sulfur (S) contained in the sulfide solid electrolyte react, and SO₂ gas is generated. In order to address this problem, Patent Document 3 states that a lithium halide is provided inside an all-solid-state lithium battery. When the lithium halide is used as a SO₂ gas adsorption material, SO₂ gas generated by the reaction between a positive electrode active material and a sulfide solid electrolyte can be removed.

However, none of Patent Documents 1 to 3 states that the initial charging and discharging efficiency of a battery using a halide-based solid electrolyte is improved by adding a lithium halide. In addition, the effects obtained by adding a lithium halide include eliminating a member for fixing external pressure in Patent Document 1, obtaining high ion conductivity in Patent Document 2, and using it as a SO₂ adsorption material in Patent Document 3, which are different battery characteristics from the initial charging and discharging efficiency effect of the present invention. That is, according to Patent Documents 1 to 3, it is not possible to improve the initial charging and discharging efficiency of a battery using a halide-based solid electrolyte.

A solid electrolyte battery using a halide-based solid electrolyte has a large irreversible capacity during initial charging and discharging, and the initial charging and discharging efficiency may not be sufficient.

The present invention has been made in view of the above circumstances and an object of the present invention is to provide a negative electrode for a solid electrolyte battery and a solid electrolyte battery which have excellent initial charging and discharging efficiency.

### Solution to Problem

In order to achieve the above object, the following aspects are provided.

(1) A negative electrode for a solid electrolyte battery according to a first aspect includes a negative electrode active material, a first compound, and a second compound. The first compound is AₐE_{b}G_{c}X_{d} . . . (1). The second compound is different from the first compound, and at least one of LiX . . . (2) and Li_{c}E_{f}F_{g}Xₕ . . . (3). In Formula (1) to Formula (3), A is Li, or Li and Na or Ca. E is at least one element selected from the group consisting of Al, Sc, Y, Zr, Hf, and lanthanoids. G is at least one group selected from the group consisting of OH, BO₂, BO₃, BO₄, B₃O₆, B₄O₇, CO₃, NO₃, AlO₂, SiO₃, SiO₄, Si₂O₇, Si₃O₉, Si₄O₁₁, Si₆O₁₈, PO₃, PO₄, P₂O₇, P₃O₁₀, SO₃, SO₄, SO₅, S₂O₃, S₂O₄, S₂O₅, S₂O₆, S₂O₇, S₂O₈, BF₄, PF₆, BOB, (COO)₂, N, AlCl₄, CF₃SO₃, CH₃COO, CF₃COO, OOC—(CH₂)₂—COO, OOC—CH₂—COO, OOC—CH(OH)—CH(OH)—COO, OOC—CH(OH)—CH₂—COO, C₆H₅SO₃, OOC—CH=CH—COO, OOC—CH=CH—COO, C(OH)(CH₂COOH)₂COO, ASO₄, BiO₄, CrO₄, MnO₄, PtF₆, PtCl₆, PtBr₆, PtI₆, SbO₄, SeO₄, TeO₄, HCOO, CN, and SCN. X is at least one element selected from the group consisting of F, Cl, Br, and I. 0.5≤a<6, 0<b<2, 0.1<c≤6, 0<d≤6.1, 0.5≤e<6, 0<f<2, 1.35≤g≤6.1, and 0≤h≤6.1 are satisfied.
(2) In the negative electrode for a solid electrolyte battery according to the above aspect, the second compound may be provided between the negative electrode active material and the first compound.
(3) In the negative electrode for a solid electrolyte battery according to the above aspect, the second compound may contain LiF.
(4) In the negative electrode for a solid electrolyte battery according to the above aspect, the second compound may contain Li₂ZrF₆.
(5) In the negative electrode for a solid electrolyte battery according to the above aspect, the mass % of the first compound may be larger than the mass % of at least one compound of the compound represented by Formula (2) and the compound represented by Formula (3).
(6) In the negative electrode for a solid electrolyte battery according to the above aspect, the mass % of the first compound may be larger than the mass % of the second compound.
(7) In a cross section of the negative electrode for a solid electrolyte battery according to the above aspect cut in a lamination direction, the average particle size of the negative electrode active material may be larger than the average particle size of at least one compound of the compound represented by Formula (2) and the compound represented by Formula (3).
(8) In a cross section of the negative electrode for a solid electrolyte battery according to the above aspect cut in a lamination direction, 30% or more of the length of the periphery of the negative electrode active material may be covered with the second compound.
(9) A solid electrolyte battery according to a second aspect includes the negative electrode for a solid electrolyte battery according to the above aspect, a positive electrode, and a solid electrolyte layer that is provided between the negative electrode for a solid electrolyte battery and the positive electrode and contains a solid electrolyte.
(10) In the solid electrolyte battery according to the above aspect, the solid electrolyte may be the same as the first compound.

### Advantageous Effects of Invention

The negative electrode for a solid electrolyte battery and the solid electrolyte battery according to the above aspects have excellent initial charging and discharging efficiency.

### BRIEF DESCRIPTION OF DRAWINGS

FIG. 1 is a cross-sectional schematic view of a solid electrolyte battery according to the present embodiment.

FIG. 2 is a schematic view of a negative electrode mixture according to the present embodiment.

FIG. 3 is a schematic view of a feature part of a negative electrode according to the present embodiment.

FIG. 4 shows an initial charging and discharging curve of Example 8.

FIG. 5 shows an initial charging and discharging curve of Comparative Example 1.

FIG. 6 shows an initial charging and discharging curve of Example 30.

FIG. 7 shows an initial charging and discharging curve of Example 31.

FIG. 8 shows an initial charging and discharging curve of Comparative Example 2.

### DESCRIPTION OF EMBODIMENTS

Hereinafter, the present embodiment will be appropriately described in detail with reference to the drawings. In the drawings used in the following description, in order to facilitate understanding features of the present invention, feature parts are enlarged for convenience of illustration in some cases, and size ratios and the like between components may be different from those of actual components. Materials, sizes, and the like provided in the following description are exemplary examples not limiting the present invention, and they can be appropriately changed and implemented within a range not changing the scope and spirit of the invention.

### [Solid Electrolyte Battery]

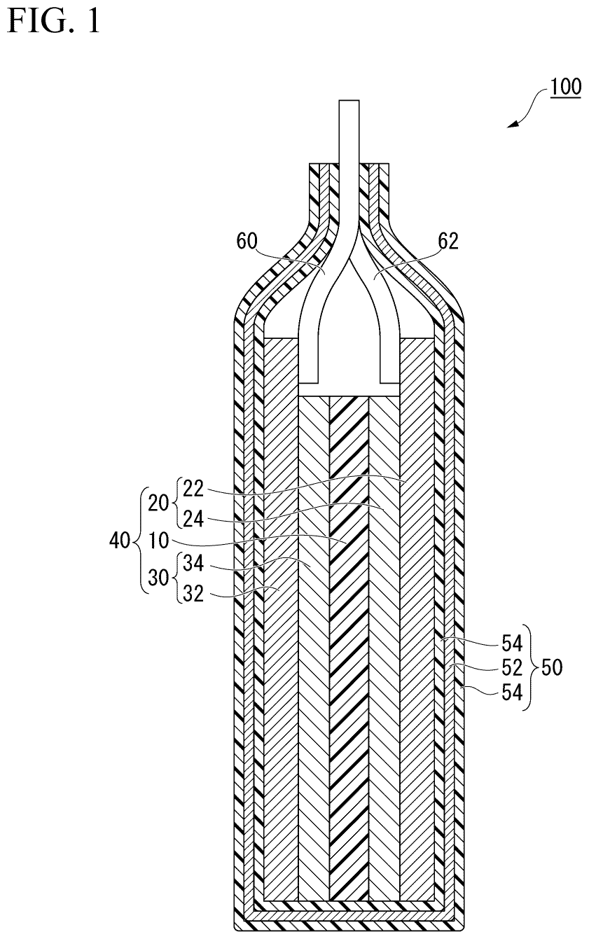

FIG. 1 is a cross-sectional schematic view of a solid electrolyte battery 100 according to the present embodiment. The solid electrolyte battery 100 shown in FIG. 1 includes a power generation element 40 and an exterior body 50. The exterior body 50 covers the periphery of the power generation element 40. The power generation element 40 is connected to the outside through a pair of terminals 60 and 62 connected to the power generation element 40. FIG. 1 shows an example in which the solid electrolyte battery 100 is a laminate-type battery, but the solid electrolyte battery 100 may be a wound battery. The solid electrolyte battery 100 is used as, for example, a laminate battery, a rectangular battery, a cylindrical battery, a coin battery, or a button battery.

### <Power Generation Element>

The power generation element 40 includes a solid electrolyte layer 10, a positive electrode 20, and a negative electrode 30. The power generation element 40 is charged or discharged by transferring ions between the positive electrode 20 and the negative electrode 30 via the solid electrolyte layer 10 and transferring electrons via an external circuit.

### “Solid Electrolyte Layer”

The solid electrolyte layer 10 is interposed between the positive electrode 20 and the negative electrode 30. The solid electrolyte layer 10 contains a solid electrolyte that can move ions by an externally applied voltage. For example, the solid electrolyte conducts lithium ions and restricts movement of electrons.

The solid electrolyte contains, for example, lithium. The solid electrolyte may be, for example, an oxide material, a sulfide material, or a halide material.

The solid electrolyte is, for example, a halide-based solid electrolyte represented by AₐE_{b}G_{c}X_{d} . . . (1). The solid electrolyte may be in the form of powder (particle) or in the form of a sintered component obtained by sintering powder. In addition, the solid electrolyte may be a molded product obtained by compressing and molding powder, a molded product obtained by molding a mixture of powder and a binder, a coating film formed by applying a paint containing powder, a binder and a solvent, then heating the applied paint, and removing the solvent, or the like.

A includes at least Li. A may include at least one of Na and Ca in addition to Li. When A includes Na or Ca, the ratio of Li to Na or Ca (molar ratio (Li:Na or Ca)) is preferably 1.00:0.03 to 1.00:0.20, and more preferably 1.00:0.04 to 1.00:0.10. Within the above range, the potential window on the reduction side of the solid electrolyte layer 10 becomes wide.

a satisfies 0.5≤a<6, preferably satisfies 2.0≤a≤4.0, and more preferably satisfies 2.5≤a≤3.5. When E is Zr or Hf, a preferably satisfies 1.0≤a≤3.0, and more preferably satisfies 1.5≤a≤2.5. In the compound represented by Formula (1), when a satisfies 0.5≤a<6, the amount of Li contained in the compound becomes appropriate, and the ion conductivity of the solid electrolyte layer 10 increases.

E is an essential component, and at least one element selected from the group consisting of Al, Sc, Y, Zr, Hf, and lanthanoids (La, Ce, Pr, Nd, Pm, Sm, Eu, Gd, Tb, Dy, Ho, Er, Tm, Yb, and Lu). E preferably includes Al, Sc, Y, Zr, Hf, and La, and more preferably includes Zr and Y. E improves the ion conductivity of the solid electrolyte layer 10. b satisfies 0<b<2. Since the effect obtained by incorporating E is obtained more effectively, b preferably satisfies 0.65≤b. In addition, E is an element forming the framework of the solid electrolyte layer 10. More preferably, b satisfies b 1.

G is, for example, at least one group selected from the group consisting of OH, BO₂, BO₃, BO₄, B₃O₆, B₄O₇, CO₃, NO₃, AlO₂, SiO₃, SiO₄, Si₂O₇, Si₃O₉, Si₄O₁₁, Si₆O₁₈, PO₃, PO₄, P₂O₇, P₃O₁₀, SO₃, SO₄, SOS, S₂O₃, S₂O₄, S₂O₅, S₂O₆, S₂O₇, S₂O₈, BF₄, PF₆, BOB, (COO)₂, N, AlCl₄, CF₃SO₃, CH₃COO, CF₃COO, OOC—(CH₂)₂—COO, OOC—CH₂—COO, OOC—CH(OH)—CH(OH)—COO, OOC—CH(OH)—CH₂—COO, C₆H₅SO₃, OOC—CH=CH—COO, OOC—CH=CH—COO, C(OH)(CH₂COOH)₂COO, AsO₄, BiO₄, CrO₄, MnO₄, PtF₆, PtCl₆, PtBrb, PtI₆, Sb₀₄, SeO₄, TeO₄, HCOO, CN, and SCN. G is preferably at least one group selected from the group consisting of OH, SO₄, CH₃COO, CF₃COO, HCOO, CN, and SCN, and particularly preferably SO₄. When G is included, the potential window on the reduction side of the solid electrolyte layer 10 becomes wider and reduction is less likely to occur.

c satisfies 0.1<c≤6. Since the effect obtained by widening the potential window on the reduction side due to the inclusion of G becomes more significant, c preferably satisfies 0.5≤c. c preferably satisfies c≤3 so that the ion conductivity of the solid electrolyte does not decrease when the G content is too high.

X is at least one selected from the group consisting of F, Cl, Br, and I. In order to increase the ion conductivity of the solid electrolyte, X is preferably at least one selected from the group consisting of Cl, Br, and L, preferably includes Br and/or I, and particularly preferably includes I. When X includes F, X preferably includes F and two or more selected from the group consisting of Cl, Br, and I because the solid electrolyte has high ion conductivity.

When X is F, the solid electrolyte has sufficiently high ion conductivity and excellent oxidation resistance. When X is Cl, the solid electrolyte has high ion conductivity and a favorable balance between oxidation resistance and reduction resistance. When X is Br, the solid electrolyte has sufficiently high ion conductivity and a favorable balance between oxidation resistance and reduction resistance. When X is I, the solid electrolyte has high ion conductivity.

d satisfies 0<d≤6.1. d preferably satisfies 1≤d. When d satisfies 1≤d, the strength of the pellet increases when the solid electrolyte is press-molded into a pellet. In addition, when d satisfies 1≤d, the ion conductivity of the solid electrolyte increases. In addition, d preferably satisfies d≤5 so that the potential window of the solid electrolyte does not become narrow due to insufficient G because the X content is too high.

Examples of solid electrolytes include Li₂ZrSO₄Cl₄, Li₂ZrCO₃Cl₄, Li₂Zr((COO)₂)_{0.5}Cl₅, Li₂Zr(CH₃COO)_{0.2}Cl_{5.8}, Li₂Zr(CF₃COO)_{0.2}Cl_{5.8}, Li₂Zr(HCOO)_{0.4}Cl_{5.6}, Li₂ZrBO₂Cl₅, Li₂ZrBF₄Cl₅, Li₃YSO₄Cl₄, Li₃YCO₃Cl₄, Li₃YBO₂Cl₅, and Li₃YBF₄Cl₅.

### “Positive Electrode”

As shown in FIG. 1, the positive electrode 20 includes a plate-like (foil-like) positive electrode current collector 22 and a positive electrode mixture layer 24. The positive electrode mixture layer 24 is in contact with at least one surface of the positive electrode current collector 22.

### (Positive Electrode Current Collector)

The positive electrode current collector 22 may be made of an electronically conductive material that can withstand oxidation during charging and is resistant to corrosion. The positive electrode current collector 22 is made of, for example, a metal such as aluminum, stainless steel, nickel, or titanium, or a conductive resin. The positive electrode current collector 22 may have a powder, foil, punched, or expanded form.

### (Positive Electrode Mixture Layer)

The positive electrode mixture layer 24 contains a positive electrode active material, and as necessary, contains a solid electrolyte, a binder and a conductivity aid.

### (Positive Electrode Active Material)

The positive electrode active material is not particularly limited as long as lithium ions can be reversibly occluded/released and inserted/detached (intercalated/deintercalated), and positive electrode active materials used in known lithium-ion secondary batteries can be used. Examples of positive electrode active materials include lithium-containing metal oxides and lithium-containing metal phosphorus oxides.

Examples of lithium-containing metal oxides include lithium cobalt oxides (LiCoO₂), lithium nickel oxides (LiNiO₂), lithium manganese spinels (LiMn₂O₄), composite metal oxides represented by General Formula: LiNiₓCo_{y}Mn_{z}O₂ (x+y+z=1), lithium vanadium compounds (LiVOPO₄, Li₃V₂(PO₄)₃), olivine type LiMPO₄ (provided that M is at least one selected from among Co, Ni, Mn, and Fe), and lithium titanates (Li₄Ti₅O₁₂).

In addition, the positive electrode active material may not contain lithium. Examples of such positive electrode active materials include lithium-free metal oxides (MnO₂, V₂O₅, etc.), lithium-free metal sulfides (MoS₂, etc.), and lithium-free fluorides (FeF₃, VF₃, etc.). When a positive electrode active material containing no lithium is used, the negative electrode is doped with lithium ions in advance, or a negative electrode containing lithium ions is used.

### (Binder)

The binder binds the positive electrode active material, the solid electrolyte and the conductivity aid to each other within the positive electrode mixture layer 24, and firmly adheres the positive electrode mixture layer 24 and the positive electrode current collector 22. The positive electrode mixture layer 24 preferably contains a binder. It is preferable that the binder have oxidation resistance and favorable adhesiveness.

Examples of binders used in the positive electrode mixture layer 24 include polyvinylidene fluoride (PVDF) or its copolymers, polytetrafluoroethylene (PTFE), polyamide (PA), polyimide (PI), polyamideimide (PAI), polybenzimidazole (PBI), polyethersulfone (PES), polyacrylic acid (PA) and its copolymers, metal ion crosslinked products of polyacrylic acid (PA) and its copolymers, polypropylene (PP) grafted with maleic anhydride, polyethylene (PE) grafted with maleic anhydride, and mixtures thereof. Among these, PVDF is particularly preferably used as the binder.

The amount of the solid electrolyte in the positive electrode mixture layer 24 is not particularly limited, and is preferably 1 mass % to 50 mass % and more preferably 5 mass % to 30 mass % based on the total mass of the positive electrode active material, the solid electrolyte, the conductivity aid and the binder.

The amount of the binder in the positive electrode mixture layer 24 is not particularly limited, and is preferably 1 mass % to 15 mass % and more preferably 3 mass % to 5 mass % based on the total mass of the positive electrode active material, the solid electrolyte, the conductivity aid and the binder. When the amount of the binder is too small, it tends to not be possible to form the positive electrode 20 with sufficient adhesive strength. On the other hand, when the amount of the binder is too large, it tends to be difficult to obtain a sufficient volume or mass energy density. This is because general binders are electrochemically inert and do not contribute to the discharging capacity.

### (Conductivity Aid)

The conductivity aid improves the electron conductivity of the positive electrode mixture layer 24. A known conductivity aid can be used. The conductivity aid is, for example, a carbon material such as carbon black, graphite, carbon nanotubes, or graphene, a metal such as aluminum, copper, nickel, stainless steel, iron, or an amorphous metal, a conductive oxide such as ITO, or a mixture thereof. The conductivity aid may be in the form of powder or fiber.

The amount of the conductivity aid in the positive electrode mixture layer 24 is not particularly limited. When a conductivity aid is added, generally, the mass proportion of the conductivity aid based on the total mass of the positive electrode active material, the solid electrolyte, the conductivity aid and the binder is preferably 0.5 mass % to 20 mass %, and more preferably 1 mass % to 5 mass %.

### “Negative Electrode”

As shown in FIG. 1, the negative electrode 30 includes a negative electrode current collector 32 and a negative electrode mixture layer 34. The negative electrode mixture layer 34 is in contact with the negative electrode current collector 32.

### (Negative Electrode Current Collector)

The negative electrode current collector 32 only needs to have electron conductivity. The negative electrode current collector 32 is, for example, a metal such as copper, aluminum, nickel, stainless steel, or iron, or a conductive resin. The negative electrode current collector 32 may have a powder, foil, punched, or expanded form.

### (Negative Electrode Mixture Layer)

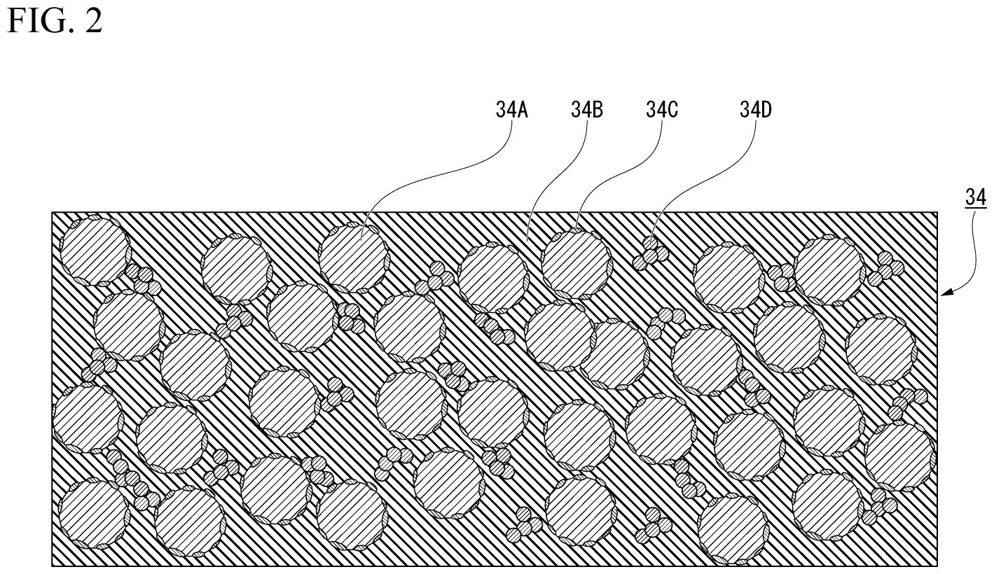

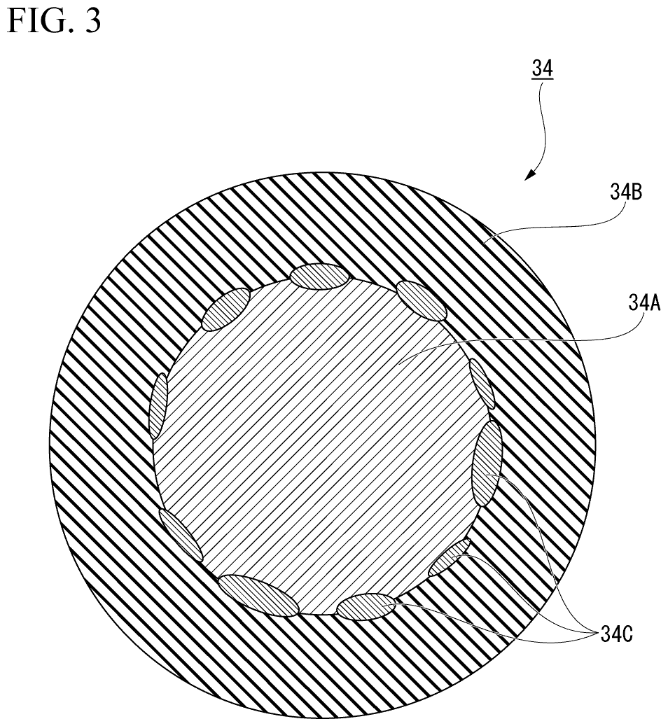

The negative electrode mixture layer 34 contains a negative electrode active material 34A, a first compound 34B, and a second compound 34C. FIG. 2 is a schematic view showing an enlarged feature part of the negative electrode mixture layer 34. The negative electrode mixture layer 34 may contain a binder and a conductivity aid 34D. As the binder and the conductivity aid 34D, known products can be used. The conductivity aid 34D is, for example, carbon black. The conductivity aid 34D may be a vapor growth carbon fiber (VGCF), a carbon nanotube, a metal or the like. In addition, FIG. 3 is a schematic view showing an enlarged vicinity of one negative electrode active material 34A of the negative electrode mixture layer 34.

The negative electrode active material 34A is not particularly limited as long as lithium ions can be reversibly occluded and released, and lithium ions can be reversibly inserted and detached. As the negative electrode active material 34A, negative electrode active materials used in known lithium-ion secondary batteries can be used.

Examples of negative electrode active materials 34A include carbon materials such as natural graphite, artificial graphite, mesocarbon microbeads, mesocarbon fibers (MCF), cokes, glassy carbon, and a fired organic compound product, metals that can be combined with lithium such as Si, SiOₓ, Sn, and aluminum, alloys thereof, composite materials of these metals and carbon materials, oxides such as lithium titanate (Li₄Ti₅O₁₂) and SnO₂, and metal lithium. The negative electrode active material 34A is preferably natural graphite.

The first compound 34B is AₐE_{b}G_{c}X_{d} . . . (1). The first compound 34B is the same material as the above halide-based solid electrolyte.

The second compound 34C is different from the first compound 34B. The second compound 34C is at least one of LiX . . . (2) and LiₑE_{f}F_{g}Xₕ . . . (3). The second compound 34C may be only LiX . . . (2), only LiₑE_{f}F_{g}Xₕ . . . (3), or both of these.

In Formula (2) and Formula (3), the definitions of X and E are the same as in Formula (1). Like a, e satisfies 0.5≤e<6, preferably satisfies 2.0≤e≤4.0, and more preferably satisfies 2.5≤e≤3.5. e and a may be the same value or different values. Like b, f satisfies 0<f<2, preferably satisfies 0.6≤f, and more preferably satisfies b≤1. f and b may be the same value or different values. g satisfies 1.3≤g≤6.1. h satisfies 0≤h≤6.1, preferably satisfies 1≤h, and more preferably satisfies h≤5. h may be 0. Here, in Formula (3), F is fluorine.

The compound represented by Formula (2) is, for example, LiF, LiCl, LiBr, or LiI. The compound represented by Formula (2) preferably includes LiF. The compound represented by Formula (3) is, for example, Li₂ZrF₆, Li₂ZrF₅Cl, Li₂ZrF₄Cl₂, or Li₂ZrF₃Cl₃. The compound represented by Formula (3) preferably includes Li₂ZrF₆.

The second compound 34C is provided, for example, between the negative electrode active material 34A and the first compound 34B. The second compound 34C prevents the reaction between the negative electrode active material 34A and the first compound 34B, and restricts decomposition of the first compound 34B.

For example, the second compound 34C covers at least a part of the periphery of the negative electrode active material 34A. The second compound 34C preferably covers 30% or more of the length of the periphery of the negative electrode active material 34A in a cross section of the negative electrode mixture layer 34 cut in a lamination direction. The cross-sectional image can be confirmed under, for example, a scanning electron microscope (SEM) or a transmission electron microscope (TEM).

The compounds represented by Formulae (2) and (3) are easily deformed by a physical force and chemically compatible. Therefore, the second compound 34C is coated on the surface of the negative electrode active material 34A by a physical force. In addition, the second compound 34C has high compatibility with respect to the first compound 34B, and binds between the negative electrode active material 34A and the first compound 34B at a molecular level.

The mass % of the first compound 34B contained in the negative electrode mixture layer 34 is, for example, larger than the mass % of at least one compound of the compound represented by Formula (2) and the compound represented by Formula (3). The mass % of the first compound 34B contained in the negative electrode mixture layer 34 is preferably larger than the mass % of the second compound 34C. That is, when both the compound represented by Formula (2) and the compound represented by Formula (3) are contained as the second compound 34C, the mass % of the first compound 34B is preferably larger than the sum of the mass % thereof.

The mass % of the negative electrode active material 34A contained in the negative electrode mixture layer 34 is. for example, 50 mass % or more, and preferably 60% or more. The mass % of the first compound 34B contained in the negative electrode mixture layer 34 is, for example, 20 mass % or more and 30 mass % or less. The mass % of the second compound 34C contained in the negative electrode mixture layer 34 is, for example, 10% or less.

The average particle size of the negative electrode active material 34A is, for example, larger than the average particle size of at least one compound of the compound represented by Formula (2) and the compound represented by Formula (3). The average particle size of the negative electrode active material 34A is larger than, for example, the average particle size of the second compound 34C. When the conditions are satisfied, the second compound 34C is easily inserted between the negative electrode active material 34A and the first compound 34B.

The average particle size is determined from a cross-sectional image obtained by cutting the negative electrode mixture layer 34 in a lamination direction. The cross-sectional image can be confirmed under, for example, a scanning electron microscope (SEM) or a transmission electron microscope (TEM). 10 particles of each of the negative electrode active material 34A, the first compound 34B, and the second compound 34C that can be confirmed in the cross-sectional image are extracted, and the average particle size is determined by calculating the average thereof. When the negative electrode active material 34A, the first compound 34B, and the second compound 34C have amorphous shapes, the diameter in the long axis direction is defined as the particle size.

### <Exterior Body>

The exterior body 50 accommodates the power generation element 40 therein. The exterior body 50 prevents water from entering from the outside to the inside. For example, as shown in FIG. 1, the exterior body 50 includes a metal foil 52 and a resin layer 54 laminated on each surface of the metal foil 52. The exterior body 50 is a metal laminate film in which the metal foil 52 is coated with the resin layer 54 from both sides.

The metal foil 52 is, for example, an aluminum foil or a stainless-steel foil. For the resin layer 54, for example, a resin film such as polypropylene can be used. The material constituting the resin layer 54 may be different between the inside and the outside. For example, a polymer having a high melting point, for example, polyethylene terephthalate (PET), polyamide (PA) or the like can be used as the outer material, and a resin having a lower melting point than the outer material, for example, polyethylene (PE), polypropylene (PP) or the like can be used as the inner material.

### <Terminal>

The terminals 62 and 60 are connected to the positive electrode 20 and the negative electrode 30, respectively. The terminal 62 connected to the positive electrode 20 is a positive electrode terminal, and the terminal 60 connected to the negative electrode 30 is a negative electrode terminal. The terminals 60 and 62 are responsible for electrical connection with the outside. The terminals 60 and 62 are formed of a conductive material such as aluminum, nickel, copper or the like. The connection method may be welding or screwing. In order to prevent short circuiting, it is preferable to protect the terminals 60 and 62 with an insulation tape.

### [Method of Producing Solid Electrolyte Battery]

Next, a method of producing a solid electrolyte battery according to the present embodiment will be described. First, a solid electrolyte is prepared. The solid electrolyte can be produced by, for example, a method of mixing a raw material powder containing predetermined elements at a predetermined molar ratio and causing a mechanochemical reaction. In addition, when a raw material powder containing predetermined elements at a predetermined molar ratio is mixed, molded, and sintered in a vacuum or inert gas atmosphere, a sintered solid electrolyte component may be formed.

When the raw material powder contains a halide raw material, the halide raw material tends to evaporate when the temperature increases. Therefore, a halogen may be supplemented by making a halogen gas coexist in the atmosphere during sintering. In addition, when the raw material powder contains a halide raw material, sintering may be performed by a hot press method using a highly sealable mold. In this case, since the mold is highly sealable, evaporation of the halide raw material due to sintering can be restricted. When sintering is performed in this manner, a solid electrolyte in the form of a sintered component made of a compound having a predetermined composition is obtained.

In addition, when a solid electrolyte is produced, as necessary, a heat treatment may be performed. When the heat treatment is performed, it is possible to adjust the crystallite size of the solid electrolyte. The heat treatment is preferably performed at 130° C. to 650° C. for 0.5 to 60 hours, and more preferably at 140° C. to 600° C. for 1 to 30 hours, for example, in an argon gas atmosphere. When the heat treatment is performed in an argon gas atmosphere at 150 to 550° C. for 5 to 24 hours, a solid electrolyte having a crystallite size of 5 nm to 500 nm is obtained.

The power generation element 40 can be produced using, for example, a powder molding method. In addition, for example, a paste containing a positive electrode active material is applied onto the positive electrode current collector 22 and dried to form the positive electrode mixture layer 24, and thus the positive electrode 20 is produced. In addition, for example, a paste containing the negative electrode active material 34A, the first compound 34B, and the second compound 34C is applied onto the negative electrode current collector 32 and dried to form the negative electrode mixture layer 34, and thus the negative electrode 30 is produced.

Next, for example, a guide having a hole is installed above the positive electrode 20 and the inside of the guide is filled with a solid electrolyte. Then, the surface of the solid electrolyte is leveled, and the negative electrode 30 is superimposed on the solid electrolyte. Thereby, the solid electrolyte is interposed between the positive electrode 20 and the negative electrode 30. Then, pressure is applied to the positive electrode 20 and the negative electrode 30, and thus the solid electrolyte is press-molded. When press-molding is performed, a laminate in which the positive electrode 20, the solid electrolyte layer 10 and the negative electrode 30 are laminated in this order is obtained.

Next, external terminals are welded to the positive electrode current collector 22 of the positive electrode 20 and the negative electrode current collector 32 of the negative electrode 30 that form the laminate by a known method, and the positive electrode current collector 22 or the negative electrode current collector 32 and the external terminal are electrically connected. Then, the laminate connected to the external terminals is accommodated in the exterior body 50, and the opening of the exterior body 50 is sealed by heat sealing. Through the above steps, the solid electrolyte battery 100 of the present embodiment is obtained.

When the solid electrolyte battery 100 according to the present embodiment contains the second compound 34C, it is possible to restrict reacting of the first compound 34B with the negative electrode active material 34A and decomposition thereof. When decomposition of the first compound 34B is restricted, the irreversible capacity of the solid electrolyte battery 100 decreases.

The embodiments of the present invention have been described in detail above with reference to the drawings, but configurations and combinations thereof in the embodiments are only examples, and additions, omissions, substitutions and other modifications of the configurations can be made without departing from the spirit and scope of the present invention.

### EXAMPLES

### Example 1

### (Production of Solid Electrolyte)

In a glove box with a dew point of about −70° C., the raw material powder was weighed out so that the molar ratio of zirconium chloride (ZrCl₄) and lithium sulfate (Li₂SO₄) was a ratio of 1:1. The raw material powder was poured into a zirconia sealed container for a planetary ball mill containing zirconia balls in advance. Next, a lid was set on the sealed container, the lid was screwed onto the main body of the container, and the space between the lid and the container was then sealed with a polyimide tape. The polyimide tape had an effect of blocking water. Next, the zirconia sealed container was set in a planetary ball mill. A mechanochemical reaction was caused for 24 hours at an autorotation speed of 500 rpm and a revolution speed 500 rpm in an autorotation direction and a revolution direction, which were opposite to each other, and a solid electrolyte (Li₂ZrSO₄Cl₄) was generated.

The average primary particle size of the obtained solid electrolyte was 0.1 μm. Here, the planetary ball mill was generally provided in an atmosphere (air). The zirconia sealed container for a planetary ball mill was screwed and additionally sealed with a polyimide tape, and when the zirconia sealed container was set in the planetary ball mill, since the zirconia sealed container was firmly pressed and fixed in the structure, it is thought that, generally, even in the atmosphere, almost no water enters the zirconia sealed container from the air.

### (Production of Negative Electrode Mixture)

The negative electrode mixture was also produced in a glove box with a dew point of about −70° C. As the negative electrode active material 34A, graphite (Gr) having an average particle size of 11.0 μm was used. The nominal capacity of the graphite was 342 mAhg⁻¹. In addition, the same solid electrolyte as above was used as the first compound 34B. LiF was used as the second compound 34C. Here, carbon black (CB) was used as a conductivity aid. The negative electrode active material 34A, the first compound 34B, the second compound 34C, and the conductivity aid were weighed out at a mass ratio of 67:29.60:0.40:3(=Gr:Li₂ZrSO₄Cl₄:LiF:CB), and mixed for 15 minutes using an agate pestle and a mortar to obtain a negative electrode mixture.

### (Production of Half Cell)

A half cell was also produced in a glove box with a dew point of about −70° C. The half cell was produced using a pellet production jig. The pellet production jig had a polyetheretherketone (PEEK) holder with an inner diameter of 10 mm, and an upper punch and a lower punch with a diameter of 9.99 mm. The material of the upper and lower punches was a die material (SKD11 material).

The lower punch was inserted into the PEEK holder of the pellet production jig, and 110 mg of the solid electrolyte was poured onto the lower punch. Next, the resin holder was vibrated to level the surface of the solid electrolyte, the upper punch was then inserted onto the solid electrolyte, and pressing was performed with a load of about 4 KN using a press machine.

Next, the upper punch was removed and 10 mg of the negative electrode mixture was poured onto the solid electrolyte. Next, the PEEK holder was vibrated to level the surface of the negative electrode mixture, the upper punch was then inserted onto the negative electrode mixture, and pressing was performed with a load of 3 KN using a press machine. Next, the lower punch was removed, a Li foil with a diameter of 10 mm was poured onto the solid electrolyte layer, and the lower punch was inserted. In this manner, a half cell in which the negative electrode mixture layer, the solid electrolyte layer, and the Li foil were laminated in this order was produced.

In addition, two stainless steel plates with a diameter of 50 mm and a thickness of 5 mm, and two Bakelite (registered trademark) plates with a diameter of 50 mm and a thickness of 2 mm were prepared. Next, four holes through which screws would pass were made in each of the two stainless steel plates and the two Bakelite (registered trademark) plates. When the electrochemical cell, two stainless steel plates and two Bakelite (registered trademark) plates were laminated, the holes through which screws would pass were provided at positions at which the two stainless steel plates and the two Bakelite (registered trademark) plates overlapped in a plan view, and did not overlap the electrochemical cell in a plan view.

Then, the stainless steel plate, the Bakelite (registered trademark) plate, the half cell, the Bakelite (registered trademark) plate, and the stainless steel plate were laminated in this order, and screws were inserted into the screw holes, and fastening was performed with a torque of 1 N·m. In this manner, a half cell in which the upper punch and the lower punch of the electrochemical cell were insulated by the Bakelite (registered trademark) plates was obtained. Next, the half cell was left in a thermostatic chamber at 25° C. for 48 hours to stabilize an open circuit voltage.

Using the produced half cell, electrochemical properties of the negative electrode were evaluated. The measurement was performed when the half cell was left in a thermostatic chamber at 25° C. The C rate was used to indicate the charging and discharging current. nC(mA) is a current at which the nominal capacity (mAh) can be charged and discharged at 1/n(h). Since the nominal discharging capacity of the graphite was 342 mAhg¹, the nominal capacity of the half cell was “negative electrode mixture mass (mg)”/1,000×“proportion of graphite in negative electrode mixture”×“nominal capacity of graphite (mAhg⁻¹)”=10/1,000×0.67×342=2.29 mAh. Therefore, the current at 0.01C was 2.29 mA×0.01×1,000=22.9 μA. The cell was charged at a current of 0.01C up to 5 mV (vs. Li/Li⁺), and discharged at a current of 0.01C up to 3.0 V(vs. Li/Li⁺). The initial charging and discharging efficiency of the cell of Example 1 was 59%. The initial charging and discharging efficiency was determined by the following formula.

Initial charging and discharging efficiency (%)=discharging capacity (mAh)/charging capacity (mAh)×100

Next, in a glove box, the half cell after charging and discharging was decomposed, the negative electrode mixture was taken out and cut, and the cross section was measured under a scanning electron microscope. Then, the average particle sizes of the negative electrode active material, the first compound, and the second compound were measured. In addition, it was confirmed that the second compound was provided between the negative electrode active material and the first compound.

### Comparative Example 1

Comparative Example 1 differed from Example 1 in that the second compound 34C was not added when the negative electrode mixture was produced. The mass ratio of the negative electrode active material 34A, the first compound 34B and the conductivity aid in the negative electrode mixture was 67:30:3(=Gr:Li₂ZrSO₄Cl₄:CB). The charging and discharging efficiency of Comparative Example 1 was 49%. FIG. 5 shows an initial charging and discharging curve of Comparative Example 1.

### Example 2 to Example 29

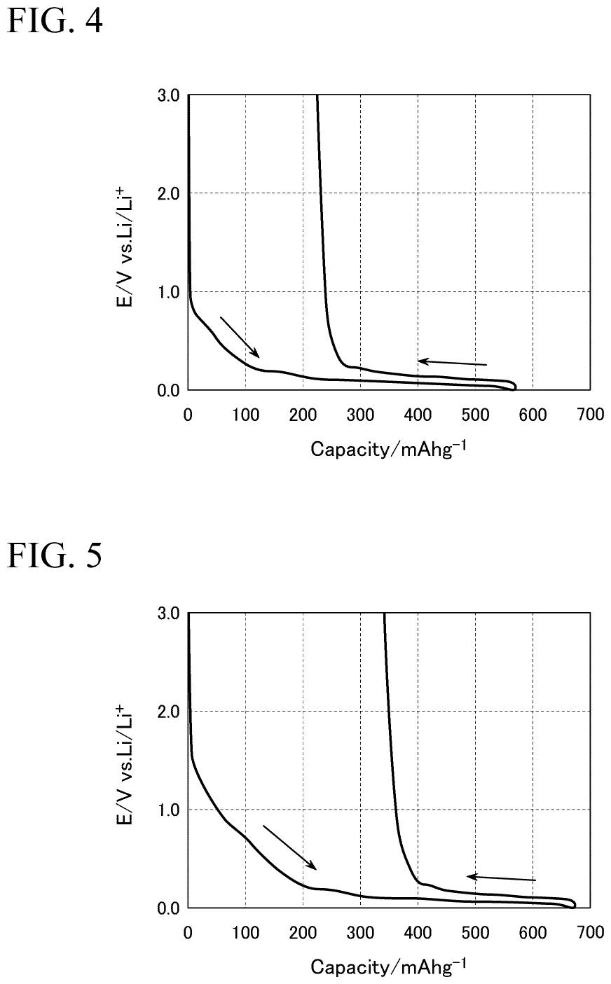

In Example 2 to Example 29, half cells were produced in the same manner as in Example 1 using the negative electrodes and solid electrolyte layers shown in Table 1 to Table 4, and the initial charging and discharging efficiency was determined under the same charging and discharging conditions as in Example 1. FIG. 4 shows an initial charging and discharging curve of Example 8.

### Example 30, Example 31, and Comparative Example 2

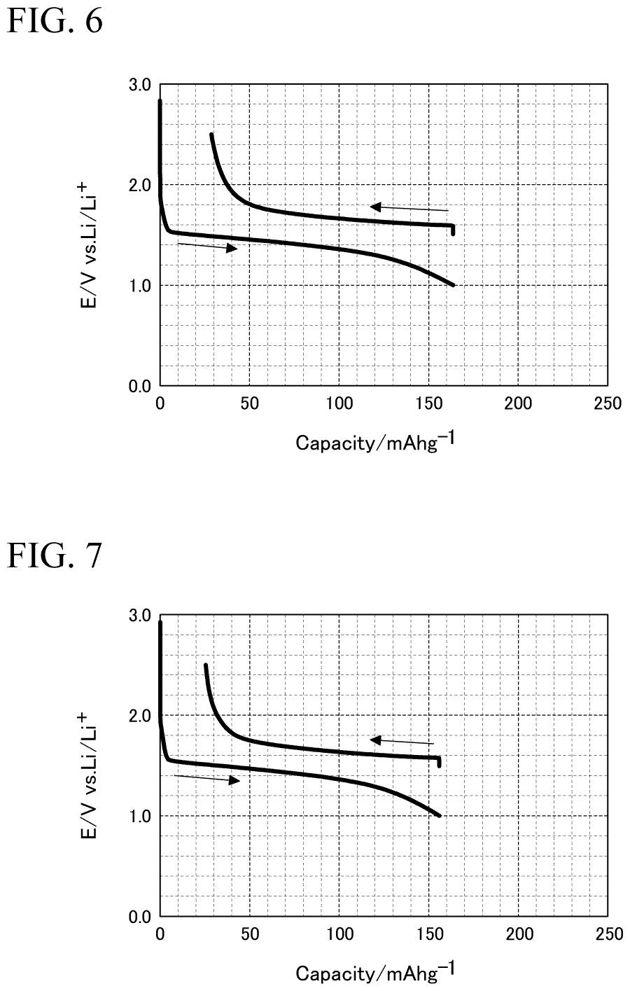

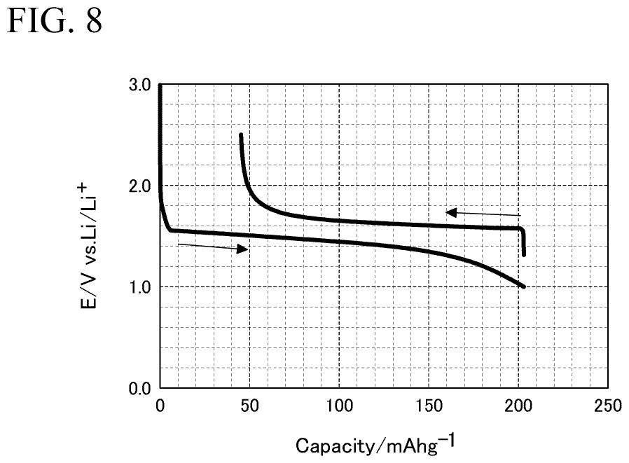

In Example 30, Example 31, and Comparative Example 2, half cells were produced in the same manner as in Example 1 using the negative electrodes and solid electrolyte layers shown in Table 2 and Table 4, and the initial charging and discharging efficiency was determined under the same charging and discharging conditions as in Example 1. In Example 30, Example 31, and Comparative Example 2, lithium titanate (LTO) was used as the negative electrode active material, and carbon nanofibers (VGCF: registered trademark) were used as the conductivity aid. FIG. 6 shows an initial charging and discharging curve of Example 30. FIG. 7 shows an initial charging and discharging curve of Example 31. FIG. 8 shows an initial charging and discharging curve of Comparative Example 2.

The results of Examples 1 to 31, Comparative Example 1, and Comparative Example 2 are summarized in the following Table 1 to Table 4. The compound (1), die compound (2), and the compound (3) in Table 1 to Table 4 corresponded to the compound represented by Formula (1), the compound represented by Formula (2), and the compound represented by Formula (3), respectively. Here, in the tables, Gr indicates graphite, and CB indicates carbon black.

TABLE 1

| | Negative electrode | | | | | | | | | |
|---|---|---|---|---|---|---|---|---|---|---|
| | | | First | | | Composition/mass % | | | | |
| | | Conduc- | compound | Second compound | | | Conduc- | | | |
| | Active | tivity | Compound | Compound | Compound | Active | tivity | Compound | Compound | Compound |
| | material | aid | (1) | (2) | (3) | material | aid | (1) | (2) | (3) |
| Example | Gr | CB | Li₂ZrSO₄Cl₄ | LiF | — | 67 | 3 | 29.60 | 0.40 | 0 |
| 1 | | | | | | | | | | |
| Example | Gr | CB | Li₂ZrSO₄Cl₄ | LiF | — | 67 | 3 | 29.40 | 0.60 | 0 |
| 2 | | | | | | | | | | |
| Example | Gr | CB | Li₂ZrSO₄Cl₄ | LiF | — | 67 | 3 | 29.25 | 0.75 | 0 |
| 3 | | | | | | | | | | |
| Example | Gr | CB | Li₂ZrSO₄Cl₄ | LiF | — | 67 | 3 | 28.90 | 1.10 | 0 |
| 4 | | | | | | | | | | |
| Example | Gr | CB | Li₂ZrSO₄Cl₄ | LiF | — | 67 | 3 | 28.40 | 1.60 | 0 |
| 5 | | | | | | | | | | |
| Example | Gr | CB | Li₂ZrSO₄Cl₄ | LiF | — | 67 | 3 | 25.00 | 5.00 | 0 |
| 6 | | | | | | | | | | |
| Example | Gr | CB | Li₂ZrSO₄Cl₄ | LiF | — | 67 | 3 | 20.00 | 10.00 | 0 |
| 7 | | | | | | | | | | |
| Example | Gr | CB | Li₂ZrSO₄Cl₄ | LiF | — | 67 | 3 | 29.60 | 0.40 | 0 |
| 8 | | | | | | | | | | |
| Example | Gr | CB | Li₂ZrSO₄Cl₄ | LiF | — | 67 | 3 | 29.20 | 0.80 | 0 |
| 9 | | | | | | | | | | |
| Example | Gr | CB | Li₂ZrSO₄Cl₄ | LiF | — | 67 | 3 | 25.00 | 5.00 | 0 |
| 10 | | | | | | | | | | |
| Example | Gr | CB | Li₂ZrSO₄Cl₄ | LiF | — | 67 | 3 | 20.00 | 10.00 | 0 |
| 11 | | | | | | | | | | |
| Example | Gr | CB | Li₂ZrSO₄Cl₄ | LiCl | — | 68 | 3 | 28.54 | 0.58 | 0 |
| 12 | | | | | | | | | | |
| Example | Gr | CB | Li₂ZrSO₄Cl₄ | LiCl | — | 68 | 3 | 27.96 | 1.17 | 0 |
| 13 | | | | | | | | | | |
| Example | Gr | CB | Li₂ZrSO₄Cl₄ | LiBr | — | 68 | 3 | 27.38 | 1.75 | 0 |
| 14 | | | | | | | | | | |
| Example | Gr | CB | Li₂ZrSO₄Cl₄ | LiI | — | 68 | 3 | 27.96 | 1.17 | 0 |
| 15 | | | | | | | | | | |
| Example | Gr | CB | Li₂ZrSO₄Cl₄ | LiF | — | 68 | 3 | 28.83 | 0.29 | 0 |
| 16 | | | | | | | | | | |
| Example | Gr | CB | Li₂ZrSO₄Cl₄ | LiF | — | 68 | 3 | 28.74 | 0.39 | 0 |
| 17 | | | | | | | | | | |

TABLE 2

| | Negative electrode | | | | | | | | | |
|---|---|---|---|---|---|---|---|---|---|---|
| | | | First | | | Composition/mass % | | | | |
| | | Conduc- | compound | Second compound | | | Conduc- | | | |
| | Active | tivity | Compound | Compound | Compound | Active | tivity | Compound | Compound | Compound |
| | material | aid | (1) | (2) | (3) | material | aid | (1) | (2) | (3) |
| Example | Gr | CB | Li₂ZrSO₄Cl₄ | LiF | — | 68 | 3 | 28.40 | 0.73 | 0 |
| 18 | | | | | | | | | | |
| Example | Gr | CB | Li₂ZrSO₄Cl₄ | LiCl | — | 67 | 3 | 29.40 | 0.60 | 0 |
| 19 | | | | | | | | | | |
| Example | Gr | CB | Li₂ZrSO₄Cl₄ | LiCl | — | 67 | 3 | 28.80 | 1.20 | 0 |
| 20 | | | | | | | | | | |
| Example | Gr | CB | Li₂ZrSO₄Cl₄ | LiI | — | 67 | 3 | 28.20 | 1.80 | 0 |
| 21 | | | | | | | | | | |
| Example | Gr | CB | Li₂Zr((COO)₂)_{0.5}Cl₅ | LiF | — | 67 | 3 | 29.6 | 0.40 | 0 |
| 22 | | | | | | | | | | |
| Example | Gr | CB | Li₂Zr(CH₃COO)Cl₅ | LiF | — | 67 | 3 | 29.6 | 0.40 | 0 |
| 23 | | | | | | | | | | |
| Example | Gr | CB | Li₂Zr(HCOO)Cl₅ | LiF | — | 67 | 3 | 29.6 | 0.40 | 0 |
| 24 | | | | | | | | | | |
| Example | Gr | CB | Li₂ZrSO₄Cl₄ | | Li₂ZrF₆ | 67 | 3 | 27 | 0.00 | 3.0 |
| 25 | | | | | | | | | | |
| Example | Gr | CB | Li₂ZrSO₄Cl₄ | | Li₂ZrF₅Cl | 67 | 3 | 27 | 0.00 | 3.0 |
| 26 | | | | | | | | | | |
| Example | Gr | CB | Li₂ZrSO₄Cl₄ | | Li₂ZrF₄Cl₂ | 67 | 3 | 27 | 0.00 | 3.0 |
| 27 | | | | | | | | | | |
| Example | Gr | CB | Li₂ZrSO₄Cl₄ | | Li₂ZrF₃Cl₃ | 67 | 3 | 27 | 0.00 | 3.0 |
| 28 | | | | | | | | | | |
| Example | Gr | — | Li₂ZrSO₄Cl₄ | | — | 70 | 0 | 30 | 0.00 | 0 |
| 29 | | | | | | | | | | |
| Example | LTO | VGCF | Li₂ZrSO₄Cl₄ | LiF | — | 55 | 5 | 39.2 | 0.80 | 0 |
| 30 | | | | | | | | | | |
| Example | LTO | VGCF | Li₂ZrSO₄Cl₄ | LiCl | — | 55 | 5 | 39.6 | 0.40 | 0 |
| 31 | | | | | | | | | | |
| Compar- | Gr | CB | Li₂ZrSO₄Cl₄ | — | — | 67 | 3 | 30 | 0.00 | 0 |
| ative | | | | | | | | | | |
| Exam- | | | | | | | | | | |
| ple 1 | | | | | | | | | | |
| Compar- | LTO | VGCF | Li₂ZrSO₄Cl₄ | — | — | 55 | 5 | 40 | 0.00 | 0 |
| ative | | | | | | | | | | |
| Exam- | | | | | | | | | | |
| ple 2 | | | | | | | | | | |

TABLE 3

| | | | | | | | | | | Initial |
|---|---|---|---|---|---|---|---|---|---|---|
| | | | | | | | | | | charging |
| | Solid electrolyte layer | | | | | | Particle size (μm) | | | and dis- |
| | Component | | | Composition/mass % | | | | Second compound | | charging |
| | Compound | Compound | Compound | Compound | Compound | Compound | Active | Compound | Compound | efficiency/ |
| | (1) | (2) | (3) | (1) | (2) | (3) | material | (2) | (3) | % |
| Example | Li₂ZrSO₄Cl₄ | — | — | 100 | — | — | 11 | 0.1 | — | 59 |
| 1 | | | | | | | | | | |
| Example | Li₂ZrSO₄Cl₄ | — | — | 100 | — | — | 11 | 0.1 | — | 60 |
| 2 | | | | | | | | | | |
| Example | Li₂ZrSO₄Cl₄ | — | — | 100 | — | — | 11 | 0.1 | — | 61 |
| 3 | | | | | | | | | | |
| Example | Li₂ZrSO₄Cl₄ | — | — | 100 | — | — | 11 | 0.1 | — | 62 |
| 4 | | | | | | | | | | |
| Example | Li₂ZrSO₄Cl₄ | — | — | 100 | — | — | 11 | 0.1 | — | 61 |
| 5 | | | | | | | | | | |
| Example | Li₂ZrSO₄Cl₄ | — | — | 100 | — | — | 11 | 0.1 | — | 56 |
| 6 | | | | | | | | | | |
| Example | Li₂ZrSO₄Cl₄ | — | — | 100 | — | — | 11 | 0.1 | — | 50 |
| 7 | | | | | | | | | | |
| Example | Li₂ZrSO₄Cl₄ | — | — | 100 | — | — | 11 | 7 | — | 59 |
| 8 | | | | | | | | | | |
| Example | Li₂ZrSO₄Cl₄ | — | — | 100 | — | — | 11 | 7 | — | 61 |
| 9 | | | | | | | | | | |
| Example | Li₂ZrSO₄Cl₄ | — | — | 100 | — | — | 11 | 7 | — | 53 |
| 10 | | | | | | | | | | |
| Example | Li₂ZrSO₄Cl₄ | — | — | 100 | — | — | 11 | 7 | — | 51 |
| 11 | | | | | | | | | | |
| Example | Li₂ZrSO₄Cl₄ | — | — | 100 | — | — | 11 | 26 | — | 57 |
| 12 | | | | | | | | | | |
| Example | Li₂ZrSO₄Cl₄ | — | — | 100 | — | — | 11 | 26 | — | 56 |
| 13 | | | | | | | | | | |
| Example | Li₂ZrSO₄Cl₄ | — | — | 100 | — | — | 11 | 25 | — | 56 |
| 14 | | | | | | | | | | |
| Example | Li₂ZrSO₄Cl₄ | — | — | 100 | — | — | 11 | 20 | — | 56 |
| 15 | | | | | | | | | | |
| Example | Li₂ZrSO₄Cl₄ | LiF | — | 99.1 | 0.9 | 0 | 11 | 7 | — | 59 |
| 16 | | | | | | | | | | |
| Example | Li₂ZrSO₄Cl₄ | LiF | — | 98.8 | 1.2 | 0 | 11 | 7 | — | 64 |
| 17 | | | | | | | | | | |

TABLE 4

| | | | | | | | | | | Initial |
|---|---|---|---|---|---|---|---|---|---|---|
| | Solid electrolyte layer | | | | | | Particle size (μm) | | | charging |
| | Component | | | Composition/mass % | | | | Second compound | | and dis- |
| | Com- | Com- | Com- | Com- | Com- | Com- | | Com- | Com- | charging |
| | pound | pound | pound | pound | pound | pound | Active | pound | pound | efficiency/ |
| | (1) | (2) | (3) | (1) | (2) | (3) | material | (2) | (3) | % |
| Example | Li₂ZrSO₄Cl₄ | LiF | — | 97.5 | 2.5 | 0 | 11 | 7 | — | 58 |
| 18 | | | | | | | | | | |
| Example | Li₂ZrSO₄Cl₄ | LiCl | — | 98.0 | 2.0 | 0 | 11 | 26 | — | 57 |
| 19 | | | | | | | | | | |
| Example | Li₂ZrSO₄Cl₄ | LiCl | — | 96.0 | 4.0 | 0 | 11 | 26 | — | 59 |
| 20 | | | | | | | | | | |
| Example | Li₂ZrSO₄Cl₄ | LiI | — | 93.9 | 6.1 | 0 | 11 | 20 | — | 56 |
| 21 | | | | | | | | | | |
| Example | Li₂Zr((COO)₂)_{0.5}Cl₅ | — | — | 100 | — | — | 11 | 0.1 | — | 63 |
| 22 | | | | | | | | | | |
| Example | Li₂Zr(CH₃COO)Cl₅ | — | — | 100 | — | — | 11 | 0.1 | — | 66 |
| 23 | | | | | | | | | | |
| Example | Li₂Zr(CH₃COO)Cl₅ | — | — | 100 | — | — | 11 | 0.1 | — | 67 |
| 24 | | | | | | | | | | |
| Example | Li₂ZrSO₄Cl₄ | — | — | 100 | — | — | 11 | — | 0.1 | 61 |
| 25 | | | | | | | | | | |
| Example | Li₂ZrSO₄Cl₄ | — | — | 100 | — | — | 11 | — | 0.1 | 62 |
| 26 | | | | | | | | | | |
| Example | Li₂ZrSO₄Cl₄ | — | — | 100 | — | — | 11 | — | 0.1 | 64 |
| 27 | | | | | | | | | | |
| Example | Li₂ZrSO₄Cl₄ | — | — | 100 | — | — | 11 | — | 0.1 | 65 |
| 28 | | | | | | | | | | |
| Example | Li₂ZrSO₄Cl₄ | LiF | — | 98.8 | 1.2 | 0 | 11 | 7 | — | 55 |
| 29 | | | | | | | | | | |
| Example | Li₂ZrSO₄Cl₄ | — | — | 100 | — | — | 6 | 26 | — | 83 |
| 30 | | | | | | | | | | |
| Example | Li₂ZrSO₄Cl₄ | — | — | 100 | — | — | 6 | 7 | — | 84 |
| 31 | | | | | | | | | | |
| Compar- | Li₂ZrSO₄Cl₄ | — | — | 100 | — | — | 11 | — | — | 49 |
| ative | | | | | | | | | | |
| Exam- | | | | | | | | | | |
| ple 1 | | | | | | | | | | |
| Compar- | Li₂ZrSO₄Cl₄ | — | — | 100 | — | — | 6 | — | — | 78 |
| ative | | | | | | | | | | |
| Exam- | | | | | | | | | | |
| ple 2 | | | | | | | | | | |

All the cells using the negative electrodes shown in Examples 1 to 29 had a higher initial charging and discharging efficiency than the cell using the negative electrode shown in Comparative Example 1. In addition, all the cells using the negative electrodes shown in Examples 30 and 31 had a higher initial charging and discharging efficiency than the cell using the negative electrode shown in Comparative Example 2. That is, when the second compound was added into the battery, the initial charging and discharging efficiency was improved.

### REFERENCE SIGNS LIST

10 Solid electrolyte layer
20 Positive electrode
22 Positive electrode current collector
24 Positive electrode mixture layer
30 Negative electrode
32 Negative electrode current collector
34 Negative electrode mixture layer
34A Negative electrode active material
34B First compound
34C Second compound
34D Conductivity aid
40 Power generation element
50 Exterior body
52 Metal foil
54 Resin layer
60, 62 Terminal
100 Solid electrolyte battery

1. A negative electrode for a solid electrolyte battery, comprising a negative electrode active material, a first compound, and a second compound,
wherein the first compound is AₐE_{b}G_{c}X_{d} . . . (1), and
wherein the second compound is different from the first compound, and is at least one of LiX . . . (2) and LiₑE_{f}F_{g}Xₕ . . . (3),
wherein in Formula (1) to Formula (3),
A is Li, or Li and Na or Ca,
E is at least one element selected from the group consisting of Al, Sc, Y, Zr, Hf, and lanthanoids,
G is at least one group selected from the group consisting of OH, BO₂, BO₃, BO₄, B₃O₆, B₄O₇, CO₃, NO₃, AlO₂, SiO₃, SiO₄, Si₂O₇, Si₃O₉, Si₄O₁₁, Si₆O₁₈, PO₃, PO₄, P₂O₇, P₃O₁₀, SO₃, SO₄, SO₅, S₂O₃, S₂O₄, S₂O₅, S₂O₆, S₂O₇, S₂O₈, BF₄, PF₆, BOB, (COO)₂, N, AlCl₄, CF₃SO₃, CH₃COO, CF₃COO, OOC—(CH₂)₂—COO, OOC—CH₂—COO, OOC—CH(OH)—CH(OH)—COO, OOC—CH(OH)—CH₂—COO, C₆H₅SO₃, OOC—CH=CH—COO, OOC—CH=CH—COO, C(OH)(CH₂COOH)₂COO, AsO₄, BiO₄, CrO₄, MnO₄, PtF₆, PtCl₆, PtBr₆, PtI₆, SbO₄, SeO₄, TeO₄, HCOO, CN, and SCN,
X is at least one element selected from the group consisting of F, Cl, Br, and I, and
0.5≤a<6, 0<b<2, 0.1<c≤6, 0<d≤6.1, 0.5≤e<6, 0<f<2, 1.3≤g≤6.1, and 0≤h≤6.1 are satisfied.

2. The negative electrode for a solid electrolyte battery according to claim 1,
wherein the second compound is provided between the negative electrode active material and the first compound.

3. The negative electrode for a solid electrolyte battery according to claim 1,
wherein the second compound contains LiF.

4. The negative electrode for a solid electrolyte battery according to claim 1,
wherein the second compound contains Li₂ZrF₆.

5. The negative electrode for a solid electrolyte battery according to claim 1,
wherein the mass % of the first compound is larger than the mass % of at least one compound of the compound represented by Formula (2) and the compound represented by Formula (3).

6. The negative electrode for a solid electrolyte battery according to claim 1,
wherein the mass % of the first compound is larger than the mass % of the second compound.

7. The negative electrode for a solid electrolyte battery according to claim 1,
wherein, in a cross section cut in a lamination direction, the average particle size of the negative electrode active material is larger than the average particle size of at least one compound of the compound represented by Formula (2) and the compound represented by Formula (3).

8. The negative electrode for a solid electrolyte battery according to claim 1,
wherein, in a cross section cut in a lamination direction, 30% or more of the length of the periphery of the negative electrode active material is covered with the second compound.

9. A solid electrolyte battery, comprising the negative electrode for a solid electrolyte battery according to claim 1, a positive electrode, and a solid electrolyte layer that is provided between the negative electrode for a solid electrolyte battery and the positive electrode and contains a solid electrolyte.

10. The solid electrolyte battery according to claim 9,
wherein the solid electrolyte is the same as the first compound.
